(19) United States
(12) Patent Application Publication
(10) Pub. No.: US 2013/0292112 A1
(43) Pub. Date: Nov. 7, 2013

(54) COMPOSITION AND METHOD FOR LOCATING PRODUCTIVE ROCK FRACTURES FOR FLUID FLOW

(71) Applicant: Lloyd Lester Davis, Jemez Springs, NM (US)

(72) Inventor: Lloyd Lester Davis, Jemez Springs, NM (US)

(73) Assignee: LOS ALAMOS NATIONAL SECURITY, LLC, Los Alamos, NM (US)

(21) Appl. No.: 13/617,279

(22) Filed: Sep. 14, 2012

Related U.S. Application Data
(60) Provisional application No. 61/641,368, filed on May 2, 2012.

(51) Int. Cl. C09K 8/80; E21B 49/00

(52) U.S. Cl. 166/254.1; 507/200; 507/269; 507/239; 507/243; 507/219

(57) ABSTRACT

A particle mixture useful for estimating the locations of rock fractures in rock includes a mixture of particles of proppant with particles of an energetic material having a size, shape, and density that are about the same as for the particles of proppant. Particles of proppant and of an energetic material having the same desired sizes and shapes of the proppant may be obtained by collecting those particles that pass through a sieve of a chosen size but not through a sieve of the next smaller size. The location of rock fractures that contain proppant can be estimated by sending the particle mixture into fractured rock, allowing the energetic particles to release their energy, and afterward estimating the locations in the rock where the energy was released from the particles, thereby providing the locations of fractures in the rock that contain proppant.

### RELATED APPLICATIONS

This application claims the benefit of U.S. Provisional Patent Application No. 61/641,368 entitled “Locating Productive Rock Fractures for Fluid Flow and Composition,” filed May 2, 2012, hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to locating rock fractures and to mixtures of proppant and energetic particles for propping open rock fractures and locating them for fluid flow.

### BACKGROUND OF THE INVENTION

There is a trend toward production of hydrocarbons from unconventional, inherently low permeability reservoirs. This trend has prompted a large increase in the use of hydraulic fracturing of rock. Operators and service companies in the oil and gas industry need to be able to determine and/or estimate the location and extent of hydraulically induced fractures that have been placed into rock. This information is important to these operators and companies who are exploring these unconventional reservoirs for the production of hydrocarbons. This information about the fractures frequently is estimated using microseismic detection and location methods that are used create a map of fractures in the rock.

The productive portion of fractured rock is the portion through which fluids such as oil and gas can flow from the fractured rock to a wellbore for production later at the surface. It can be difficult to identify the productive portion of an induced fracture of the rock using current microseismic detection methods because these methods do not provide information related to the locations of the fractures in the rock that contain proppants. Proppants are high strength materials (silica, for example) that are put into the fractures to keep the fractures open (i.e to prop open). Proppants prevent the fractures from closing. Proppants make the fractures and the rock productive because the productive portion of the hydraulic fracture, i.e. the portion that contains proppant, can be expected to stay open with a aperture width that is sufficient for fluid flow once hydraulic fracture fluids flow from inside the fractures and back to the surface, which reduces the pressure within the fracture. This pressure reduction may allow fractures that do not contain proppant to close. Closed and/or un-propped fractures are unproductive to fluid flow. Fluids such as oil and gas can't reach a wellbore through unproductive rock.

### SUMMARY OF THE INVENTION

The present invention provides a particle mixture useful for producing and locating productive fractures in rock. The particle mixture includes a homogeneous mixture of proppant particles and energetic particles. The proppant particles have about the same size, shape, and density that the energetic particles have.

The present invention also provides a method for estimating the location of proppant particles in rock fractures. The method involves providing a homogeneous particle mixture comprising particles of proppant and particles of an energetic material. The particles of proppant have about the same size, shape, and density that the energetic particles have. The particle mixture is sent into fractured rock. Afterward, when the energetic particles release their energy, the locations in the rock where the energy is released are determined, which provides the locations of the fractures that contain proppant particles.

### DETAILED DESCRIPTION

This invention is concerned with mixtures of particles that include energetic particles and proppant particles. The invention is also concerned with a process that uses these mixtures to provide information about productive fractures in rock. Embodiment particle mixtures include explosive particles whose size, shape, and density are matched to the size, shape and density of proppant particles. By matching, it is meant that the sizes, shapes, and densities of the proppant particles are the same or close to the same as those of the energetic particles. By close to the same, it is meant that when a homogeneous mixture of these particles is sent into a fracture, as the particle mixture flows, the particle mixture does not segregate such that proppant particles as a whole do not flow faster or slower than the energetic particles as a whole. If there is no segregation based upon differences in particles sizes, shapes, and densities, then proppant particles flow at the same rate as do energetic particles and where one would find energetic particles, there would also be proppant particles.

Particles having the same size and shape or close to the same size and shape may also be characterized as particles that will pass through the same size sieve (e.g. a U.S. Standard Size 30 sieve) but not through the next smaller size sieve (e.g. U.S. Standard 35 sieve). Particles having the same sizes, shapes, and densities, or close to the same sizes, shapes, and densities are expected to exhibit the same or very similar flow as they pass through rock fractures.

In an embodiment, the energetic material of the energetic particles is chosen based upon their critical temperature such that their critical temperature is matched to the conditions of a reservoir. A “critical temperature” is defined as the lowest temperature at which thermal decomposition of an explosive (i.e. an energetic material) that results in a reaction that leads to a violent event such as an explosion. A simple and commonly used method for determining the critical temperature is the HENKIN test. The HENKIN test involves pressing a small (ca. 50 mg.) sample into an aluminum detonator shell and immersing it in an isothermal bath of molten Woods' metal, and recording the time to explosion of the sample. More sophisticated methods (e.g. calorimetric methods) for determining the critical temperature are also known. Frank-Kaminetskii (Acta Physicochem. USSR, 1939, 10, 365) describes a relationship between physical and chemical properties of a material with critical temperature of an isothermally heated sample. The invention is not limited to any particular method for determining the critical temperature of an energetic sample. The invention is also not limited to materials having a particular critical temperature.

After an embodiment mixture of proppant particles and energetic particles is sent into fractured rock, the particles from the mixture will move through fractures in the rock. The sizes of the proppant particles and the energetic particles are about the same, as are their shapes and densities. These characteristics do not necessarily have to exactly match, but they should be suitably close so that the flow of the particles through fractured rock is not affected by whether the particles are proppant particles or energetic particles and the particles do not substantially segregate based upon their sizes, shapes or densities because they will be the same or similar to one another. Both proppant and energetic particles flow into the fractures, and it is expected that fractures that contain proppant particles also contain energetic particles. Thus, when the energetic particles release their energy (by exploding, for example), microseismic detection methods may be used to determine the locations of the explosions. Since the mixture of explosive particles and proppant particles are chosen with sizes, shapes, and densities that do not distinguish explosive particles from proppant particles, they are both expected to flow through the fractures and become located one another in the fractures without any discrimination based upon size, shape, or density, as these parameters are about the same for both proppant particles and energetic particles. Thus, when the energetic particles explode and their locations are estimated or determined using microseismic methods, the location of the explosion also reveals the location of the proppant particles, thereby also revealing the location of productive fractures in the rock.

Currently available proppant materials are diverse. They include sintered bauxite, ceramic particles manufactured with varying densities, glass, and sand that may vary from unprocessed to highly processed and resin-coated. In a preferred embodiment, proppant particles are nominally spherical in order to minimize bridging and improve flow. A size range generally between 0.1 and 1 mm diameter exists, with more refined size distributions available for specific proppants. Apparent specific gravity fir the commonly used proppant particles is generally in the range of 2.5 to 3.5 g/cc.

The energetic particles that are a portion of the particle mixture that also include proppant may be referred to as microseismic tracer particles. They trace the location of the fracture when they explode (i.e. the microseismic event). The location of the explosion is also the location of the productive fractures because the proppant particles are also located with the energetic particles in the same fractures, which are believed to be productive fractures for the subsequent flow of fluids such as hydrocarbons.

Fractures that do not contain proppant are not expected to also contain explosive particles after the mixture of proppant and explosive particles has been sent into the fractured rock.

By sending the particulate mixture into the rock, one can discriminate between rock fractures that contain proppant with rock fractures that do not contain proppant. If a microseismic event (i.e. an explosion) is not detected at a location in the rock, then it is reasonable to assume that that location does not contain a productive fracture, i.e. a fracture that is propped open by proppant.

Embodiment particle mixtures are designed with energetic particles (i.e. the microseismic tracer particles) that have about the same size and shape as the proppant particles that they are chosen to work with Initiation of the energetic particles can be a result of, for example, mechanical stress, thermal decomposition at the reservoir temperature, and the like. The initiation of the energetic particle by thermal decomposition would occur within a suitable time window and with sufficient energy release to be detectable using a known method for detecting microseismic events. In addition, the energetic particles are also chemically inert to the conditions of the reservoir over a timeframe long enough for them to function as intended for a thermal initiation. Embodiment mixtures containing less than 1% by weight of energetic particles are envisioned to provide a reasonable compromise between the effectiveness of the proppant mixture in holding fractures open, number of microseismic events, and transportation costs.

The energetic particles that are chosen for the mixture include an energetic material that releases energy that can be detected. Current methods can resolve energy release as small as −4 on the magnitude scale devised by Charles Richter, which correlates with an energy release of 63 milliJoules. Since most known explosives have energy densities between 1 and 5 Joules per milligram, there is a considerable range of suitable candidates. In some embodiments, a consideration for matching the energetic particles to a reservoir is to match the temperature of the reservoir with the critical temperature of the explosive mixture chosen. Another consideration is that not all explosives decompose at elevated temperature with an energy release rate that is sufficient for microseismic detection.

Once the apparent specific gravity and particle size for a proppant are selected, the energetic particles (microseismic tracer particles) may be designed and manufactured to correspond for a mixture of them with the selected proppant. One method for designing and manufacturing the energetic particles is crystallization in which the crystallization process results in the formation of energetic crystals of a desired size that, when coated with an appropriate layer of a polymeric resin, the final diameter and apparent specific gravity are matched to the proppant. Crystallization is a very well known technique, as is the preparation of crystals of a desired size. Another method is to control the composition of a molding powder, together with the conditions for warm isostatic pressing, so that the explosive particles produced are matched to the proppant. Yet another method is envisioned as a variant of the Olin process for the manufacture of double-based ball powder propellants. All of these possible methods for making energetic particles can be controlled to afford particles of a desired size, shape, and density.

An embodiment energetic particle of this invention is a particle of lead azide. Particles of lead azide suitable with this invention include lead azide particles that have been recrystallized in the presence of dextrin to a desired dimension, for example, a nominal dimension of 543 microns that passes through a No. 30 U.S. standard sieve not through a No. 35 U.S. standard sieve, and coated uniformly with a layer of high-temperature resin such that the final product is able to pass a No. 20 sieve. Some non-limiting examples of these resins include for example TEFLON (DuPont Teflon AF 1600 is a specific form of polytetrafluorethylene which is soluble in certain solvents), a thermoset polyimide coating such as poly(4,4′-oxydiphenylene-pyromellitimide) of which a soluble intermediate—poly(amic acid)—exists (as used in Unitech RP50, for example), or a high temperature epoxy such as the reaction product of poly(bisphenol A-co-epichlorohydrin) with a polyamide amine mixture (as employed in Aremco 805). Lead azide may be chosen as an example explosive in this embodiment because of its high critical temperature (about 350° C.) which is somewhat dependent on morphology and other chemical constituents, and well known violent thermal response. Polymers are chosen that possess suitable mechanical properties, a maximum temperature that matches or exceeds the critical temperature of the explosive component, and are chemically unreactive under the conditions of the reservoir. The product microseismic tracer particle in this embodiment is intended to provide a reasonable match in density and specific gravity to processed sand at U.S. standard sieve No. 20. It should be understood that these sieve sizes are only examples to be used for collecting particles of proppant and energetic material having the same or about the same sizes and shapes, and that other embodiments might use other standard sieves e.g. U.S. Standard sieve 1.0, 12, 14, 16, 18, 20, 25, 30, 35, 40, etc.) that may be used for collecting other sizes of particles.

Another embodiment particle is an intimate mixture of commercial dextrinated lead azide at approximately 60 weight percent with approximately 40 weight percent of a high temperature epoxy such as the reaction product of poly(bisphenol A-co-epichlorohydrin) with a polyamide amine mixture (Aremco 805), which is subsequently formed into particles of the appropriate size, degassed and cured.

Yet another embodiment microseismic tracer particle is comprised of one of the metal-nitrotetrazolate explosives described by Hiskey and Huynh (U.S. Pat. Nos. 7,498,446; 7,592,462; 7,741,353; 7,875,725; and 7,999,116 incorporated herein by reference) containing approximately 25-30% by weight of tungsten semicarbide (W₂C) further processed with a high-temperature resin.

Still another embodiment microseismic tracer parade is comprised of approximately equal proportions of finely divided lead azide (such as commercial dextrinated lead azide) with another explosive such as the iron complex of the nitrotetrazolate anion (NH₄)₂[Fe^{II}(H₂O)₂(NT)₄] described by Hiskey and Huynh, together with a thermally stable fluorocarbon binder such as DuPont Teflon AP-1600. Proportions are adjusted to control the final particle density and critical temperature, the mixture is processed into a molding powder from a lacquer in solvent such as FC-75 by the usual method, and compacted by warm isostatic pressing to final density.

Still another embodiment microseismic tracer particle is comprised of a co-crystal of two or more explosives, coated with a thermoset polyimide resin or other suitable resin.

In summary, a composition and method for estimating the location of rock fractures in rock has been invented. An embodiment composition is a particle mixture of particles of proppant with particles of an energetic material having a size, shape, and density that are about the same as for the particles of proppant. Parades of proppant and of an energetic material having the same desired sizes and shapes of the proppant may be obtained by collecting that pass through a sieve of a chosen size but not through a sieve of the next smaller size. The location of rock fractures that contain proppant can be estimated by sending the particle mixture into fractured rock, allowing the energetic particles to release their energy, and afterward estimating the locations in the rock where the energy was released from the particles, thereby providing the locations of fractures in the rock that contain proppant.

Although the present invention has been described with reference to specific details, it is not intended that such details should be regarded as limitations upon the scope of the invention, except as and to the extent that they are included in the accompanying claims.

What is claimed is:

1. A particle mixture for estimating the location of rock fractures in rock, said particle mixture comprising a mixture of particles of proppant and particles of an energetic material, wherein the particles of proppant have the same or about the same sizes, shapes, and densities as the particles of said energetic material have.

2. The particle mixture of claim 1, wherein said proppant comprises silica sand, sintered bauxite, glass, ceramic, or mixtures thereof.

3. The particle mixture of claim 1, wherein said particles of an energetic material comprises an azide material.

4. The particle mixture of claim 1, wherein said particles of an energetic material comprise a metal complex containing the nitrotetrazolate ligand or salt.

5. The particle mixture of claim 3, wherein said azide material comprises lead azide.

6. The particle mixture of claim 1, wherein the particles of an energetic material comprise a coating.

7. The particle mixture of claim 6, Wherein said coating comprises resin.

8. A resin-coated particle of lead azide.

9. A method for estimating the location of rock fractures that contain proppant, comprising:
providing a particle mixture comprising particles of proppant and particles of an energetic material, said particles of proppant and particles of energetic material, wherein the particles of proppant have the same or about the same sizes, shapes, and densities as the particles of said energetic material have,
sending the particle mixture into fractured rock, and afterward
allowing the energetic particles to release their energy, and afterward
estimating the locations in the rock where the energy was released from the particles, thereby estimating the locations of fractures in the rock that contain proppant.
